(19) United States
(12) Patent Application Publication
(10) Pub. No.: US 2017/0119213 A1
(43) Pub. Date: May 4, 2017

(54) ELECTRICALLY HEATED BOTTOM INJECTION NOZZLE

(71) Applicants: Michael D. Newman, Hillsborough, NJ (US); Thomas Edward Killburn, Pennsburg, PA (US)

(72) Inventors: Michael D. Newman, Hillsborough, NJ (US); Thomas Edward Killburn, Pennsburg, PA (US)

(21) Appl. No.: 14/931,898

(22) Filed: Nov. 4, 2015

(51) Int. Cl. A47J 43/07; B05B 15/02

(52) U.S. Cl. CPC A47J 43/07; B05B 15/02

(57) ABSTRACT

A cryogen injection apparatus for injecting a cryogenic substance into a blender, includes at least one nozzle constructed for being in fluid communication with an interior of the blender; and an electric heat sink member in contact with the at least one nozzle for electrically heating said nozzle. A related method is also provided.

### BACKGROUND OF THE INVENTION

The present embodiments relate to bottom injection of cryogen into mixers for cooling and more particularly, to nozzle apparatus that introduce cryogen substances into food products for chilling and/or freezing same, and which apparatus are not clogged from use of the cryogenic substance.

The bottom injection of cryogen into mixers for cooling food products, for example, are known. Such known bottom injection nozzles for cryogenic substances, such as for example liquid nitrogen (LIN), encounter difficulties when being used with wet products which are drawn into an orifice of the nozzle in communication with the food processing equipment, whereupon the wet food product is frozen upon exposure to the cryogen. When such a situation occurs, the nozzle orifice will become restricted and eventually clogged. Unfortunately, it is extremely difficult to clear the nozzle, frequently requiring disassembly of same, and no further cooling cryogenic substance can be delivered to the mixer for chilling until the clog is removed.

Existing nozzle structure contributes to this deficiency. That is, known nozzles are made from either thick stainless steel, which transfers a large amount of heat from the mixture or blender wall and thereafter remains cold after an injection cycle of the cryogen until the mixing is complete. This type of stainless steel nozzle contributes to the clogging situation when the cryogenic substance, such as LIN for example, is exposed to the wet product in the blender or mixer.

Other nozzles are manufactured with a teflon sleeve which reduces the amount of heat transfer from the blender wall to the nozzle, but such nozzles are susceptible to migration of the food product between the sleeve and the housing and will therefore crack the nozzle due to thermal expansion and contraction from the cryogenic substance.

### SUMMARY OF THE INVENTION

There is therefore provided an electrically heated bottom injection nozzle apparatus which consists of a cryogen injection apparatus for injecting a cryogenic substance into a blender, including at least one nozzle constructed for being in fluid communication with an interior of the blender; and an electric heat sink member in contact with the at least one nozzle for electrically heating said nozzle.

There is also provided herein a method for electrically heating a bottom injection nozzle to eliminate clogging of the nozzle, which includes providing an electric heat sink to said injection nozzle upon conclusion of injecting the cryogenic substance to the blender and transmitting power to the electric heat sink for warming the injection nozzle.

In summary, the present embodiments include a low thermal mass straight bore nozzle with an integrated heating system which provides for rapid thawing of the nozzle and therefore, clearing of any product within the nozzle between injection cycles of the cryogen, such as liquid nitrogen (LIN). The construction of the nozzle embodiment eliminates the possibility of cracking of the nozzle because there are no internal sleeves used which could permit thermal expansion and contraction of any frozen food product or condensate between the nozzle body and the thermal sleeve.

### BRIEF DESCRIPTION OF THE DRAWINGS

For a more complete understanding of the present invention, reference may be had to the following description of exemplary embodiments considered in connection with the accompanying drawing Figures, of which:

FIG. 1 shows a perspective view of the cryogen injection nozzle embodiment of the present invention; and

FIG. 2. shows a side view partially in cross-section of the embodiment of FIG. 1.

### DETAILED DESCRIPTION OF THE INVENTION

Before explaining the inventive embodiments in detail, it is to be understood that the invention is not limited in its application to the details of construction and arrangement of parts illustrated in the accompanying drawings, since the invention is capable of other embodiments and being practiced or carried out in various ways. Also, it is to be understood that the phraseology or terminology employed herein is for the purpose of description and not of limitation.

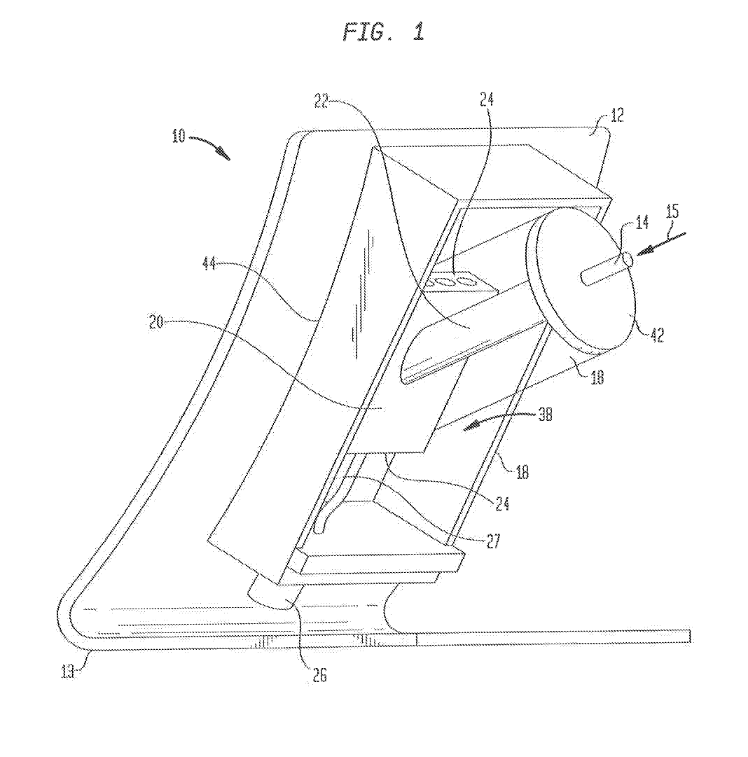

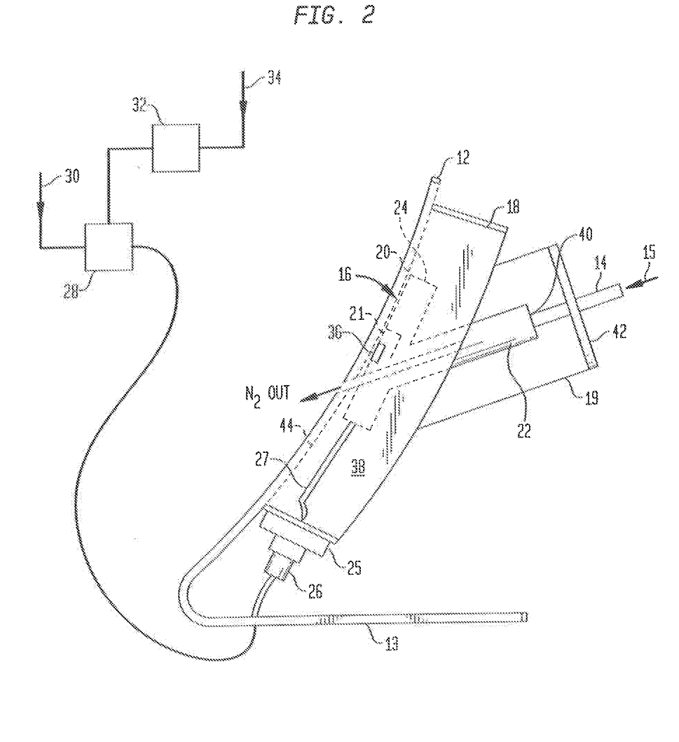

Referring to FIGS. 1-2, an electrically heated injection nozzle apparatus of the present invention is shown generally at 10 mounted to a wall 12 of a blender or mixer (not shown) in which food product (not shown) is disposed for being chilled. While food product is referred to for being treated by the injection nozzle 10, it is understood that other types of products can be treated with the present injection nozzle embodiment. The apparatus 10 is shown mounted near or at a bottom region 13 of the blender wall 12.

The injection nozzle apparatus 10 or apparatus consists of a nozzle or nozzle portion 14 for introducing a cryogen such as for example LIN represented by the arrow 15 through the nozzle into the blender; a heat sink member 16; and an enclosure 18 or housing.

The nozzle 14 can be either a straight bore stainless steel tube or a machined steel tube with an expanding bore, wherein a diameter of the bore increases along the flow path in the direction of the wall 12. The nozzle 14 is constructed from a material that has a low thermal mass.

The heat sink member 16 is used to transfer heat to the blender wall 12 and the nozzle 14. The heat sink member 16 is constructed with a first heat sink portion 20 for the blender wall and a second heat sink portion 22 for the nozzle 14. The first and second heat sink portions 20, 22 may also be formed as an integral unit. The heat sink member 16 is used for transferring heat into the blender wall 12 and to the nozzle 14. As shown in FIGS. 1-2, the heat sink member 16, which includes the first and second heat sink portions 20, 22, can be constructed from copper, and the second portion 22 surrounds and is in direct contact with a substantial area of the nozzle 14. The first heat sink portion 20 is in direct contact with the blender wall 12.

Electric cartridge heaters 24 are mounted to or embedded in the heat sink member 16 and connected to a conduit connection 26 at a sidewall of the enclosure 18. Usually, such sidewall will be at or near a bottom 25 of the enclosure 18. Electrical connectors 27 interconnect the heat sink member 16 with the conduit connection 26. The conduit connection 26 is wired to a semi-conductor controlled rectifier (SCR) 28 as shown in FIG. 2, which conducts the electrical current to the heat sink member 16. Electric power 30 shown in FIG. 2 is provided to the SCR 28. A controller or a proportional-integral-derivative controller (PID controller) 32 is connected to the SCR 28 and receives input 34 for defrosting or thawing with the apparatus 10. That is, the electric cartridge heaters 24 are powered by the SCR 28 and the PID controller 32, so that the power can be regulated to defrost or thaw the blender wall 12 and the nozzle 14 in a select amount of time. For example, rapid defrost would mean that increased power will be applied to the heat sink member 16, while a permissible longer duration of defrost will require less power.

A thermocouple 36 is positioned at an exterior surface of the first heat sink portion 20 as shown in FIG. 2. The thermocouple 36 can be mounted in a cavity 21 of the portion 20 such that the thermocouple is in facing contact with the wall 12 when the enclosure 18 is mounted to the blender wall. The thermocouple 36 will shut down or stop the defrost operation of the apparatus 10 when a desired set point temperature is reached, which can be for example above 32° F. or 0° C.

The second heat sink portion 22 is sized and shaped with a bore 40 therethrough which is constructed to receive the nozzle 14 to be extended through the second heat sink portion and the blender wall 12 for opening into the blender. The enclosure 18 is provided with a cylindrical portion 19 extending therefrom and having an open end to which a cap 42 is removably mounted.

The enclosure 18 or housing is constructed and arranged to protect the nozzle 14, heat sink member 16 and the electrical cartridge heaters 24 from external impacts and water sprays that may occur in a production facility where the blender is being used. As shown in FIGS. 1-2, the enclosure 18 includes an internal space 38 or chamber of sufficient volume to support the first and second heat sink portions 20, 22, the nozzle 14, and the electric cartridge heaters 24 therein. The enclosure 18 has a sidewall at least a portion of which is open-sided at 44, such that the first heat sink portion 20 functions as a sidewall portion for the enclosure. The thermocouple 36 as shown in FIG. 2 is positioned for contacting the wall 12 as discussed above, and covered as well when the enclosure 18 is mounted or seated against the wall shown generally at 44. The enclosure 18 is contoured so that the sidewall will fit flush with an exterior surface on the blender wall 12 as shown in particular in FIG. 2 An alternate embodiment of the apparatus 10 provides the nozzle 14, the heat sink member 16, the enclosure 18 with conduit connection 26, and the thermocouple 36 as an integral unit.

The nozzle portion 14 may be constructed from stainless steel; the heat sink member 16 may be constructed from copper or any other highly conductive material, and the enclosure 18 or housing may be constructed from stainless steel or plastic.

The injection nozzle apparatus 10 of the embodiment showing in FIGS. 1-2 permits the nozzle 14 to be easily cleaned, because the only elements of the nozzle exposed to an interior of the blender is an interior of the nozzle. Therefore, hot water or other cleaning solutions can be sprayed through the nozzle portion 14 for easy cleaning without having to disassemble the injection nozzle 10.

In operation with the actual blender (not shown), a batch of food product, such as for example ground meat with ingredients therein, is placed in the blender which is started such that internal blades (not shown) of the blender mix the food product and ingredients. It is required to chill the meat during the blending operation and therefore, cryogen such as liquid nitrogen (LIN) is injected into the blender through the injection nozzle 14. That is, the LIN 15 is injected through the nozzle 14 during which heat is transferred from the wall 12 via conduction with the nozzle 14 which also has its temperature reduced to a temperature substantially similar to that of the LIN. Minimal heat is transferred between the wall 12 and the nozzle 14 due to a low thermal mass of the nozzle portion. When a desired, reduced temperature of the meat is obtained, injection of the LIN 15 is stopped and the meat is removed from the blender. The controller 32 actuates the SCR 28 for delivering power to the electric cartridge header 24 mounted or imbedded in the heat sink member 16 to warm the first and second heat sink portions 20, 22 to effectively warm and thaw the blender wall 12 and the nozzle 14. Any frozen meat or water trapped within and clogging the nozzle portion 14 is warmed and the nozzle 14 can be blown out with a high pressure nitrogen gas prior to the next operating batch being disposed in the blender. The high pressure nitrogen gas will easily discharge any matter from the nozzle into the blender. Since nitrogen is used to dislodge any material in the nozzle 14, and the next batch will be of similar composition of meat and other ingredients, there is no contamination of the next batch of the product being processed in the blender. The construction of the injection nozzle apparatus 10 permits clean-in-place (CIP) of the nozzle portion 14 without removal or disassembly of the apparatus.

It will be understood that the embodiments described herein are merely exemplary, and that one skilled in the art may make variations and modifications without departing from the spirit and scope of the invention. All such variations and modifications are intended to be included within the scope of the invention as described and claimed herein. Further, all embodiments disclosed are not necessarily in the alternative, as various embodiments of the invention may be combined to provide the desired result.

1. A cryogen injection apparatus for injecting a cryogenic substance into a blender, comprising:
at least one nozzle constructed for being in fluid communication with an interior of the blender; and
an electric heat sink member in contact with the at least one nozzle for electrically heating said at least one nozzle.

2. The apparatus of claim 1, further comprising at least one electric cartridge heater connected to and operationally associated with the electric heat sink member.

3. The apparatus of claim 1, further comprising a housing supporting the at least one nozzle and having a space therein for receipt of the electric heat sink member.

4. The apparatus of claim 3, wherein the electric heat sink member disposed in the space comprises a portion in contact with a wall of the blender.

5. The apparatus of claim 2, further comprising an SCR connected to the electric cartridge heater for delivering heating power to said electric cartridge heater.

6. The apparatus of claim 5, further comprising a controller connected to the SCR for controlling the heating power delivered from the SCR.

7. The apparatus of claim 3, wherein the housing comprises an exterior surface region having a shape conforming to a portion of the blender for being mounted flush thereto.

8. The apparatus of claim 4, further comprising a thermocouple mounted to the electric heat sink member and in communication with the SCR.

9. The apparatus of claim 1, wherein the electric heat sink member is constructed from copper.

10. The apparatus of claim 3, wherein the at least one nozzle, the electric heat sink member, and the housing are constructed as an integral unit.

11-14. (canceled)
